(19) United States
(12) Patent Application Publication
(10) Pub. No.: US 2026/0302617 A1
(43) Pub. Date: Oct. 1, 2026

(54) BROADBAND LIQUID CRYSTAL ARRAY ANTENNA STRUCTURE

(71) Applicant: TMY Technology Inc., New Taipei City (TW)

(72) Inventors: Hsi-Hsir Chou, New Taipei City (TW); Xing Lu, New Taipei City (TW)

(73) Assignee: TMY Technology Inc., New Taipei City (TW)

(21) Appl. No.: 19/326,763

(22) Filed: Sep. 12, 2025

(30) Foreign Application Priority Data
Mar. 31, 2025 (TW) 114112384

(51) Int. Cl. H01Q 3/44; H01Q 3/34; H01Q 21/06

(52) U.S. Cl. CPC H01Q 3/44; H01Q 3/34; H01Q 21/06

(57) ABSTRACT

Provided is a broadband liquid crystal array antenna structure including a first substrate layer, a second substrate layer, a third substrate layer, a first liquid crystal layer, a first surface unit, a second surface unit, a third surface unit, and a fourth surface unit. The first liquid crystal layer is stacked and connected between the second substrate layer and the third substrate layer. When the first liquid crystal layer is applied with bias voltage, the broadband liquid crystal array antenna structure performs beam scanning based on a first angular range.

### CROSS-REFERENCE TO RELATED APPLICATION

This application claims the priority benefit of Taiwan application serial no. 114112384, filed on Mar. 31, 2025. The entirety of the above-mentioned patent application is hereby incorporated by reference herein and made a part of this specification.

### BACKGROUND

### Technical Field

The disclosure relates to an antenna array structure, and in particular to a broadband liquid crystal array antenna structure.

### Related Art

Currently, a Bluetooth system, a ZigBee system, and a microstrip antenna system are mostly adopted to complete indoor positioning technology. In the traditional microstrip antenna system, components such as micro electro mechanical systems (MEMs), PIN diodes, and varactor diodes are mostly adopted to control a scanning beam of a microstrip antenna structure.

However, the MEMs and PIN diodes may only adjust a beam direction of the microstrip antenna structure to a few specific directions, and the varactor diodes may only achieve a continuous scanning function with a small scanning range. Therefore, the current microstrip antenna system is difficult to meet a requirement of high-precision ultra-wide band (UWB) indoor positioning.

### SUMMARY

In view of this, the disclosure provides a broadband liquid crystal array antenna structure having a wide beam scanning range.

An embodiment of the disclosure provides a broadband liquid crystal array antenna structure including a first substrate layer, a second substrate layer, a third substrate layer, a first liquid crystal layer, a first surface unit, a second surface unit, a third surface unit, and a fourth surface unit. The first substrate layer has a first upper surface and a first lower surface. The second substrate layer has a second upper surface and a second lower surface. The third substrate layer has a third upper surface and a third lower surface. The first liquid crystal layer is stacked and connected between the second substrate layer and the third substrate layer. The first surface unit is arranged on the first upper surface. The second surface unit is arranged on the second upper surface. The third surface unit is arranged on the third upper surface. The fourth surface unit is arranged on the third lower surface. When the first liquid crystal layer is applied with a bias voltage, the broadband liquid crystal array antenna structure performs beam scanning based on a first angular range.

In an embodiment of the disclosure, the first surface unit includes a first surface large rectangle patch and four first surface small rectangle patches. A center of the first surface large rectangle patch corresponds to a center of the first liquid crystal layer. Two of the four first surface small rectangle patches are adjacent to a first side of the first surface large rectangle patch, and another two of the four first surface small rectangle patches are adjacent to a second side of the first surface large rectangle patch. The first side is opposite to the second side.

In an embodiment of the disclosure, the second surface unit includes a second surface rectangle patch and two parasitic patch groups. A center of the second surface rectangle patch corresponds to a center of the first liquid crystal layer. One of the parasitic patch groups is adjacent to a first side of the second surface rectangle patch, and another one of the parasitic patch groups is adjacent to a second side of the second surface rectangle patch. The first side is opposite to the second side.

In an embodiment of the disclosure, the second surface rectangle patch is a main radiating patch.

In an embodiment of the disclosure, each of the parasitic patch groups includes a second surface large rectangle patch, a second surface small rectangle patch, and a second surface strip patch. The second surface large rectangle patch is connected to the second surface small rectangle patch through the second surface strip patch. The second surface large rectangle patch is adjacent to the second surface rectangle patch. The second surface small rectangle patch is connected to an edge of the second upper surface.

In an embodiment of the disclosure, the third surface unit is a metal ground layer.

In an embodiment of the disclosure, the third surface unit includes a third surface rectangle patch. The third surface rectangle patch includes three third surface slots arranged sequentially along a first direction, and a center of a second third surface slot of the three third surface slots corresponds to a center of the first liquid crystal layer.

In an embodiment of the disclosure, the third surface slot is an H-shaped slot. The H-shape of the third surface slot extends along a second direction. The first direction is opposite to the second direction.

In an embodiment of the disclosure, the fourth surface unit is a fourth surface strip patch. The fourth surface strip patch extends along a second direction and corresponds to a center of the first liquid crystal layer.

In an embodiment of the disclosure, the fourth surface strip patch is a signal feed line.

In an embodiment of the disclosure, the fourth surface strip patch is a microstrip line.

In an embodiment of the disclosure, the first surface unit, the second surface unit, the third surface unit, and the fourth surface unit are formed by metal materials.

In an embodiment of the disclosure, the first angular range is determined by a material of the first liquid crystal layer.

In an embodiment of the disclosure, the first angular range is between −42° and 42°.

In an embodiment of the disclosure, the first angular range is between −52° and 52°.

Based on the above, the broadband liquid crystal array antenna structure of the disclosure may provide a wide beam scanning range through the special structural design thereof.

### BRIEF DESCRIPTION OF THE DRAWINGS

FIG. 1A is a schematic diagram of a multi-layered structure of a broadband liquid crystal array antenna structure according to an embodiment of the disclosure.

FIG. 1B is a cross-sectional diagram of a broadband liquid crystal array antenna structure according to an embodiment of the disclosure.

FIG. 2A is a schematic diagram of a cell design of a first surface unit according to an embodiment of the disclosure.

FIG. 2B is a schematic diagram of a cell design of a second surface unit according to an embodiment of the disclosure.

FIG. 2C is a schematic diagram of a cell design of a third surface unit according to an embodiment of the disclosure.

FIG. 2D is a schematic diagram of a cell design of a fourth surface unit according to an embodiment of the disclosure.

FIG. 3A is a relationship diagram between return gain and signal frequency of a broadband liquid crystal array antenna structure according to a first embodiment of the disclosure.

FIG. 3B is a radiation pattern diagram of a broadband liquid crystal array antenna structure according to the first embodiment of the disclosure.

FIG. 4A is a relationship diagram between return gain and signal frequency of a broadband liquid crystal array antenna structure according to a second embodiment of the disclosure.

FIG. 4B is a radiation pattern diagram of a broadband liquid crystal array antenna structure according to the second embodiment of the disclosure.

FIG. 5A is a relationship diagram between return gain and signal frequency of a broadband liquid crystal array antenna structure according to a third embodiment of the disclosure.

FIG. 5B is a radiation pattern diagram of a broadband liquid crystal array antenna structure according to the third embodiment of the disclosure.

### DESCRIPTION OF THE EMBODIMENTS

Reference is now made in detail to exemplary embodiments of the disclosure, examples of the exemplary embodiments are described in the accompanying drawings. Wherever possible, the same reference numerals are used in the drawings and the description to refer to the same or like parts.

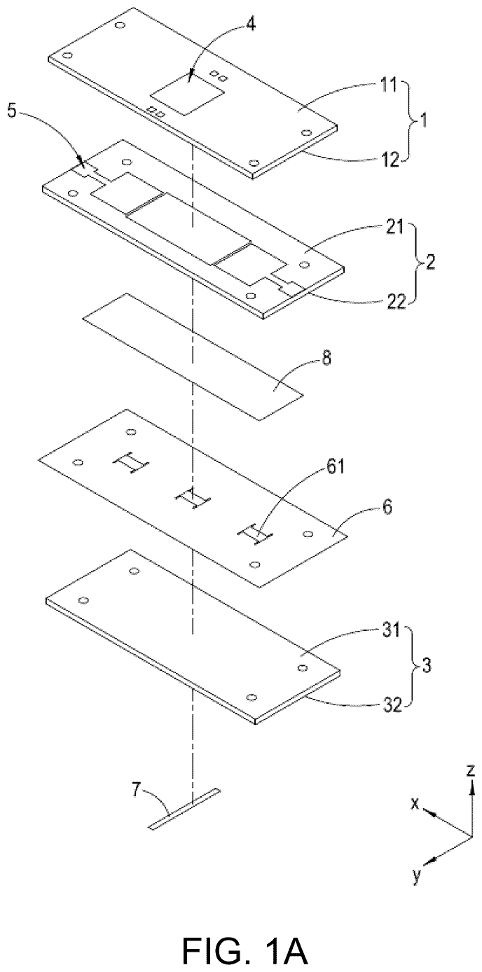

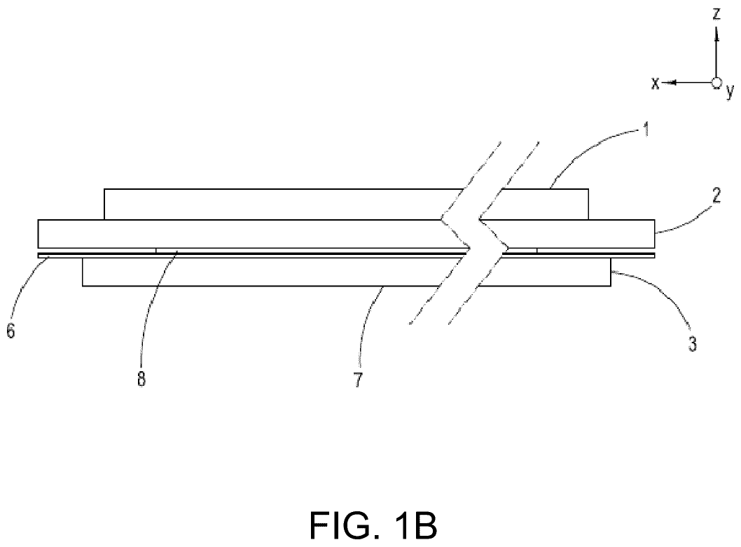

FIG. 1A is a schematic diagram of a multi-layered structure of a broadband liquid crystal array antenna structure according to an embodiment of the disclosure. FIG. 1B is a cross-sectional diagram of a broadband liquid crystal array antenna structure according to an embodiment of the disclosure. Referring to FIG. 1A and FIG. 1B, the broadband liquid crystal array antenna structure is mainly designed as a three-layered and four-surfaced circuit board, and includes a first substrate layer 1, a second substrate layer 2, a third substrate layer 3, a first surface unit 4, a second surface unit 5, a third surface unit 6, a fourth surface unit 7, and a first liquid crystal layer 8. The first substrate layer 1 has a first upper surface 11 and a first lower surface 12. The second substrate layer 2 has a second upper surface 21 and a second lower surface 22. The third substrate layer 3 has a third upper surface 31 and a third lower surface 32.

The first liquid crystal layer 8 is stacked and connected between the second substrate layer 2 and the third substrate layer 3. The first surface unit 4 is arranged on the first upper surface 11. The second surface unit 5 is arranged on the second upper surface 21. The third surface unit 6 is arranged on the third upper surface 31. The fourth surface unit 7 is arranged on the third lower surface 32. The first substrate layer 1, the second substrate layer 2, the third substrate layer 3, and the third surface unit 6 all have four circular slots. The four circular slots are arranged in pairs corresponding to adjacent two short sides of the first substrate layer 1, the second substrate layer 2, the third substrate layer 3, and the third surface unit 6, and the four circular slots of the first substrate layer 1, the second substrate layer 2, the third substrate layer 3, and the third surface unit 6 correspond to each other.

The first substrate layer 1, the second substrate layer 2, and the third substrate layer 3 may be, for example, double-sided high-frequency printed circuit boards. A board material used for the first substrate layer 1, the second substrate layer 2, and the third substrate layer 3 may be, for example, Rogers RO4533. In an embodiment, a dielectric constant of the first substrate layer 1, the second substrate layer 2, and the third substrate layer 3 may be, for example, 3.0 to 4.0 (with an optimal dielectric constant of 3.45), a tangent loss may be, for example, 0.002 to 0.003 (with an optimal tangent loss of 0.0025), and a thickness may be, for example, 0.50 to 0.51 mm (with an optimal thickness of 0.508 mm).

The first surface unit 4, the second surface unit 5, the third surface unit 6, and the fourth surface unit 7 may be, for example, formed by metal materials (for example, metal conductors such as a copper foil, a gold foil, or other metal oxide conductors such as an indium tin oxide). A copper foil thickness of the first surface unit 4, the second surface unit 5, the third surface unit 6, and the fourth surface unit 7 may be, for example, 0.035 mm. The third surface unit 6 is a metal ground layer.

A liquid crystal material used for the first liquid crystal layer 8 may be, for example, JNC ZOC-A018XX, MERCK E7, or MERCK GT7-29001, with a thickness of 0.1 mm. The first liquid crystal layer 8 has an adjustable dielectric property. When the first liquid crystal layer 8 is applied with an external voltage, the rotation of liquid crystal molecules thereof may be changed, thereby changing a dielectric constant and a tangent loss thereof.

Taking JNC ZOC-A018XX as an example, a dielectric constant and a tangent loss of the first liquid crystal layer 8 are 2.55 to 3.76 and 0.004 to 0.007, respectively. When the first liquid crystal layer 8 is applied with a bias voltage, a liquid crystal orientation direction of the first liquid crystal layer 8 is parallel to an electric field direction, and the dielectric constant of the first liquid crystal layer 8 is 3.76, with the tangent loss of 0.004. In another aspect, when the first liquid crystal layer 8 is not applied with a bias voltage, the liquid crystal orientation direction of the first liquid crystal layer 8 is vertical to the electric field, the dielectric constant becomes 2.55, and the tangent loss becomes 0.007.

Taking MERCK E7 as an example, a dielectric constant and tangent loss of the first liquid crystal layer 8 are 2.72 to 3.17 and 0.033 to 0.05, respectively. When the first liquid crystal layer 8 is applied with the bias voltage, the liquid crystal orientation direction of the first liquid crystal layer 8 is parallel to the electric field direction, and the dielectric constant of the first liquid crystal layer 8 is 3.17, with the tangent loss of 0.033. In another aspect, when the first liquid crystal layer 8 is not applied with the bias voltage, the liquid crystal orientation direction of the first liquid crystal layer 8 is vertical to the electric field, the dielectric constant becomes 2.72, and the tangent loss becomes 0.05.

Taking MERCK GT7-29001 as an example, a dielectric constant and tangent loss of the first liquid crystal layer 8 are 2.46 to 3.53 and 0.0064 to 0.0116, respectively. When the first liquid crystal layer 8 is applied with the bias voltage, the liquid crystal orientation direction of the first liquid crystal layer 8 is parallel to the electric field direction, and the dielectric constant of the first liquid crystal layer 8 is 3.53, with the tangent loss of 0.0064. In another aspect, when the first liquid crystal layer 8 is not applied with the bias voltage, the liquid crystal orientation direction of the first liquid crystal layer 8 is vertical to the electric field direction, the dielectric constant becomes 2.46, and the tangent loss becomes 0.0116.

For ease of understanding, characteristics of different liquid crystal materials are listed in Table 1.

TABLE 1

| | Dielectric | Dielectric | | | | |
|---|---|---|---|---|---|---|
| | constant | constant | Tangent loss | Tangent loss | | |
| | perpendicular | parallel | perpendicular | parallel | | |
| | to electric | to electric | to the | to the | | |
| | field | field | electric field | electric field | | Adjustment |
| | direction | direction | direction | direction | Difference | ability of |
| | (without | (with | (without | (without | in | liquid |
| Liquid | applied bias | applied bias | applied with | applied with | dielectric | crystal |
| crystal | voltage) | voltage) | bias voltage) | bias voltage) | constant | molecule |
| material | ε_{⊥} | ε_{∥} | tan δ_{⊥} | tan δ_{∥} | Δε | τ |
| JNC | 2.72 | 3.17 | 0.05 | 0.45 | 0.45 | 14.20% |
| ZOC- | | | | | | |
| A018XX | | | | | | |
| MERCK | 2.46 | 3.53 | 0.116 | 1.07 | 1.07 | 30.31% |
| E7 | | | | | | |
| MERCK | 2.55 | 3.76 | 0.007 | 1.21 | 1.21 | 32.18% |
| GT7- | | | | | | |
| 29001 | | | | | | |

A dielectric property of the first liquid crystal layer 8 changes with the electric field, thereby changing a beam characteristic of the liquid crystal array antenna structure. By further explanation, when the first liquid crystal layer 8 is not applied with the bias voltage, an arrangement direction of the liquid crystal molecules of the first liquid crystal layer 8 is parallel to a metal patch (that is, the second surface unit 5) and the metal ground layer (that is, the third surface unit 6), and the liquid crystal molecules are vertical to the electric field direction, which is called a perpendicular state. In addition, when the first liquid crystal layer 8 is applied with the bias voltage, the arrangement direction of the liquid crystal molecules of the first liquid crystal layer 8 is vertical to the metal patch and the metal ground layer, and the liquid crystal molecules are parallel to the electric field direction, which is called a parallel state.

The types of the first substrate layer 1, the second substrate layer 2, the third substrate layer 3, and the first liquid crystal layer 8 may be designed according to actual requirements, and the disclosure does not impose limitations thereon.

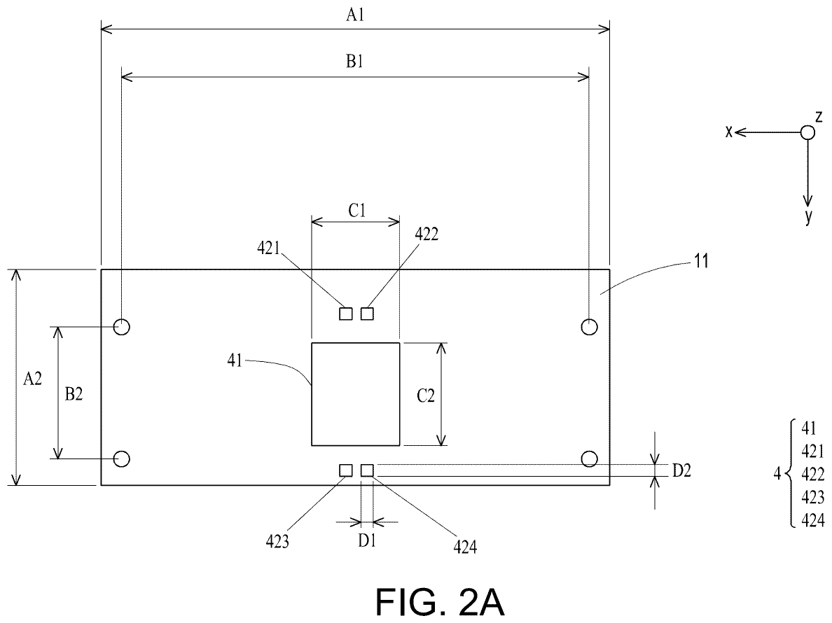

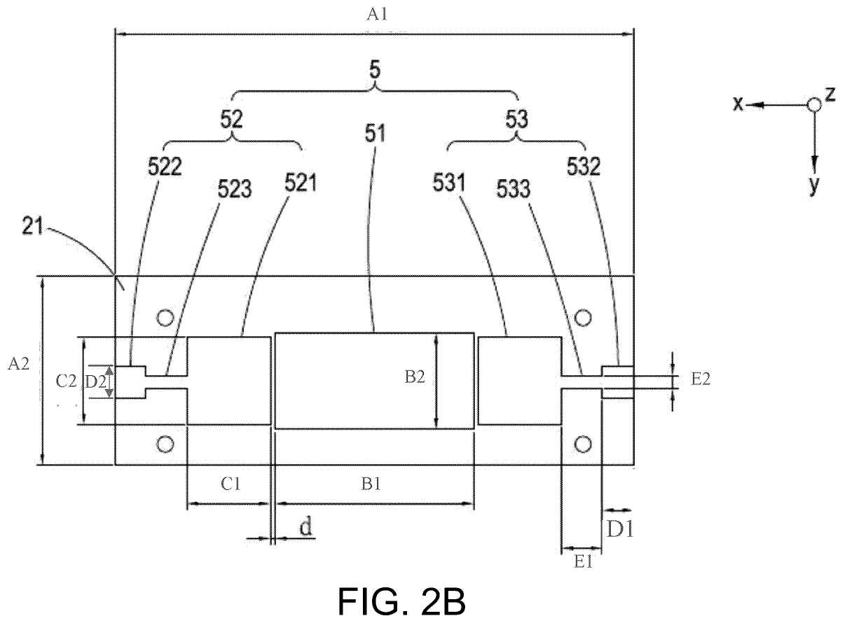

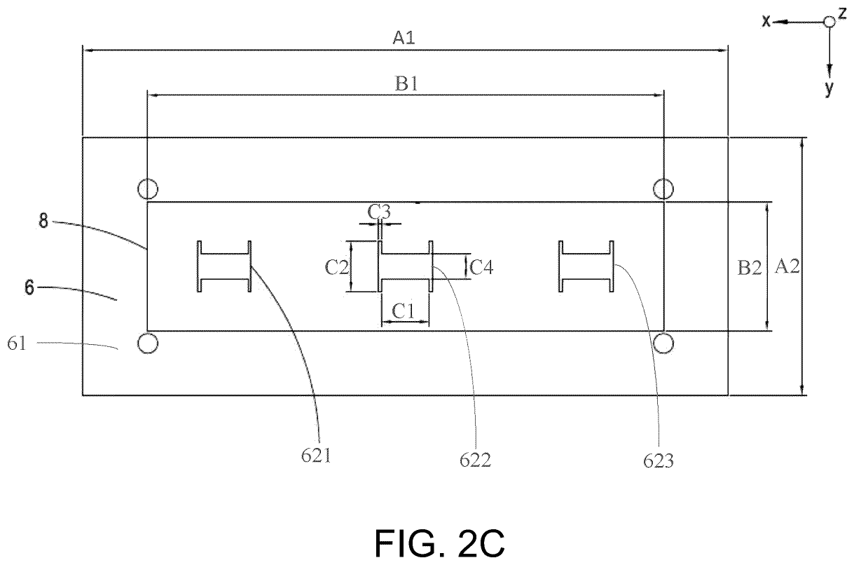

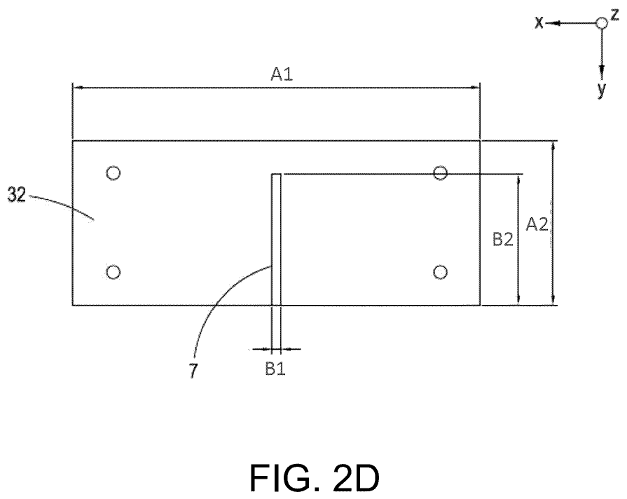

FIG. 2A is a schematic diagram of a cell design of a first surface unit according to an embodiment of the disclosure. Referring to FIG. 2A, the first surface unit 4 is located on the first upper surface 11. The original metal layer (for example, a copper foil with a thickness of 0.035 mm) on the first upper surface 11 is etched to form the first surface unit 4.

The first surface unit 4 includes a first surface large rectangle patch 41 and four first surface small rectangle patches 421 to 424. A center of the first surface large rectangle patch 41 corresponds to a center of the first liquid crystal layer 8. In addition, two first surface small rectangle patches 421 and 422 are adjacent to one side (also called the first side) of the first surface large rectangle patch 41, and the other two first surface small rectangle patches 423 and 424 are adjacent to another side (also called the second side) of the first surface large rectangle patch 41. The first side is opposite to the second side, that is, the first side is the opposite side of the second side.

A width and a length of the first upper surface 11 are A1 and A2 respectively as indicated in FIG. 2A. A distance between the circular slot on the first upper surface 11 (the first substrate layer 1) and the corresponding circular slot on the other side is B1, and a distance between the corresponding circular slot on the same side is B2.

A width and a length of the first surface large rectangle patch 41 are C1 and C2 respectively as indicated in FIG. 2A. A width and a length of each of the first surface small rectangle patches 421 to 424 are D1 and D2 respectively as indicated in FIG. 2A.

In an embodiment, the width and length (A1 and A2 as indicated in FIG. 2A) of the first upper surface 11 may be, for example, 43.50 mm to 44.50 mm (with an optimal width of 44.00 mm) and 17.50 mm to 18.50 mm (with an optimal length of 18.00 mm), respectively.

In addition, regarding a specification of the first surface unit 4, the distance (B1 as indicated in FIG. 2A) between the circular slot on the first upper surface 11 (the first substrate layer 1) and the corresponding circular slot on the other side may be, for example, 40.00 mm to 40.10 mm (with an optimal width of 40.00 mm). The distance (B2 as indicated in FIG. 2A) between the circular slot on the first upper surface 11 (the first substrate layer 1) and the corresponding circular slot on the same side may be, for example, 12.00 mm to 12.10 mm (with an optimal width of 12.00 mm). The width and the length (C1 and C2 as indicated in FIG. 2A) of the first surface large rectangle patch 41 may be, for example, 7.49 mm to 7.51 mm (with an optimal width of 7.50 mm) and 8.49 mm to 8.51 mm (with an optimal length of 8.50 mm) respectively. The width and length (D1 and D2 as indicated in FIG. 2A) of each of the first surface small rectangle patches 421 to 424 may be, for example, 0.99 mm to 1.01 mm (with an optimal width of 1.00 mm) and 0.99 mm to 1.01 mm (with an optimal length of 1.00 mm) respectively.

FIG. 2B is a schematic diagram of a cell design of a second surface unit according to an embodiment of the disclosure. Referring to FIG. 2B, the second surface unit 5 is located on the second upper surface 21. The original metal layer (for example, a copper foil with a thickness of 0.035 mm) on the second upper surface 21 is etched to form the second surface unit 5.

The second surface unit 5 includes a second surface rectangle patch 51 and two parasitic patch groups 52 and 53. A center of the second surface rectangle patch 51 corresponds to a center of the first liquid crystal layer 8, and the second surface rectangle patch 51 is the main radiating patch. The parasitic patch group 52 is adjacent to one side (also called the first side) of the second surface rectangle patch 51, and the parasitic patch group 53 is adjacent to the other side (also called the second side) of the second surface rectangle patch 51. The first side is opposite to the second side, that is, the first side is the opposite side of the second side.

The parasitic patch group 52 includes a second surface large rectangle patch 521, a second surface small rectangle patch 522, and a second surface strip patch 523. The second surface large rectangle patch 521 is connected to the second surface small rectangle patch 522 through the second surface strip patch 523. Similarly, the parasitic patch group 53 includes a second surface large rectangle patch 531, a second surface small rectangle patch 532, and a second surface strip patch 533. The second surface large rectangle patch 531 is connected to the second surface small rectangle patch 532 through the second surface strip patch 533.

The second surface large rectangle patches 521 and 531 are adjacent to the second surface rectangle patch 51. The second surface small rectangle patches 522 and 532 are connected to an edge of the second upper surface 21.

A width and a length of the second upper surface 21 are A1 and A2 as indicated in FIG. 2B, respectively.

A width and a length of the second surface rectangle patch 51 are B1 and B2 as indicated in FIG. 2B, respectively. A width and a length of each of the second surface large rectangle patches 521 and 531 are C1 and C2 as indicated in FIG. 2B, respectively. A width and a length of each of the second surface small rectangle patches 522 and 532 are D1 and D2 as indicated in FIG. 2B, respectively. A width and a length of each of the second surface strip patches 523 and 533 are E1 and E2 as indicated in FIG. 2B, respectively. A distance between the second surface large rectangle patches 521 and 531 and the second surface rectangle patch 51 is d as indicated in FIG. 2B.

In an embodiment, the width and the length (A1 and A2 as indicated in FIG. 2B) of the second upper surface 21 may be, for example, 49.50 mm to 50.50 mm (with an optimal width of 50.00 mm) and 17.50 to 18.50 mm (with an optimal length of 18.00 mm), respectively.

Additionally, regarding a specification of the second surface unit 5, the width and the length (B1 and B2 as indicated in FIG. 2B) of the second surface rectangle patch 51 may be, for example, 18.99 mm to 19.01 mm (with an optimal width of 19.00 mm) and 8.99 mm to 9.01 mm (with an optimal length of 9.00 mm), respectively. The width and the length (C1 and C2 as indicated in FIG. 2B) of each of the second surface large rectangle patches 521 and 531 may be, for example, 8.09 mm to 8.11 mm (with an optimal width of 8.10 mm) and 8.09 mm to 8.11 mm (with an optimal length of 8.10 mm), respectively. The width and the length (D1 and D2 as indicated in FIG. 2B) of each of the second surface small rectangle patches 522 and 532 may be, for example, 2.99 mm to 3.01 mm (with an optimal width of 3.00 mm) and 2.99 mm to 3.01 mm (with an optimal length of 3.00 mm), respectively. The width and the length (E1 and E2 as indicated in FIG. 2B) of each of the second surface strip patches 523 and 533 may be, for example, 3.89 mm to 3.91 mm (with an optimal width of 3.90 mm) and 0.99 mm to 1.10 mm (with an optimal length of 1.00 mm), respectively. The distance (d as indicated in FIG. 2B) between the second surface large rectangle patches 521 and 531 and the second surface rectangle patch 51 may be, for example, 0.49 mm to 0.51 mm (with an optimal length of 0.50 mm).

FIG. 2C is a schematic diagram of a cell design of a third surface unit according to an embodiment of the disclosure. Referring to FIG. 2C, the third surface unit 6 is located on the third upper surface 31. The original metal layer (for example, a copper foil with a thickness of 0.035 mm) of the third upper surface 31 is etched to form the third surface unit 6. The third surface unit 6 is a metal ground layer. Additionally, since being stacked on the third surface unit 6, the first liquid crystal layer 8 is also shown in FIG. 2C.

The third surface unit 6 includes a third surface rectangle patch 61. The third surface rectangle patch 61 includes three third surface slots 621 to 623 arranged sequentially along an X-axis (also called a first direction), and a center of the second third surface slot 622 corresponds to the center of the first liquid crystal layer 8. The third surface slots 621 to 623 are, for example, H-shaped slots. An H-shape of the H-shaped slots (that is, the third surface slots 621 to 623) extends along a Y-axis (also called a second direction). The first direction is different from the second direction.

The third upper surface 31 has the same size as the third surface rectangle patch 61, that is, a width and a length of the third upper surface 31 are the same as the width and the length of the third surface rectangle patch 61. The width and the length of the third upper surface 31 (the third surface rectangle patch 61) are A1 and A2 as indicated in FIG. 2C, respectively.

The width and the length of the first liquid crystal layer 8 are B1 and B2 as indicated in FIG. 2C, respectively.

In an embodiment, the width and the length (A1 and A2 as indicated in FIG. 2C) of the third upper surface 31 may be, for example, 49.50 mm to 50.50 mm (with an optimal width of 50.00 mm) and 19.50 mm to 20.50 mm (with an optimal length of 20.00 mm), respectively.

Additionally, the width and the length (B1 and B2 as indicated in FIG. 2C) of the first liquid crystal layer 8 may be, for example, 40.00 mm to 40.10 mm (with an optimal width of 40.05 mm) and 10.00 mm to 10.10 mm (with an optimal length of 10.05 mm), respectively.

Furthermore, regarding a specification of the third surface unit 6, the third surface slots 621 to 623 have the same specifications. Taking the third surface slot 622 as an example, the lengths of C1, C2, C3, and C4 as indicated in FIG. 2C are, for example, 3.64 mm to 3.66 mm (with an optimal length of 3.65 mm), less than 3.99 to 4.01 mm (with an optimal length of 4.00 mm), 0.24 mm to 0.26 mm (with an optimal length of 0.25 mm), and 1.99 mm to 2.01 mm (with an optimal length of 2.00 mm), respectively. As shown in FIG. 2C, both sides of the H-shaped slot (that is, the third surface slot 622) have equal length.

FIG. 2D is a schematic diagram of a cell design of a fourth surface unit according to an embodiment of the disclosure. Referring to FIG. 2D, the fourth surface unit 7 is located on the third lower surface 32. The original metal layer (for example, a copper foil with a thickness of 0.035 mm) on the third lower surface 32 is etched to form the fourth surface unit 7.

The fourth surface unit 7 is a fourth surface strip patch. Specifically, the fourth surface unit 7 may be, for example, a microstrip line. The fourth surface strip patch 7 extends along the Y-axis (also called the second direction), and the fourth surface strip patch 7 corresponds to the center of the first liquid crystal layer 8.

The third lower surface 32 has the same size as the third upper surface 31. A width and a length of the third lower surface 32 are A1 and A2 as indicated in FIG. 2D, respectively.

A width and a length of the fourth surface unit 7 are B1 and B2 as indicated in FIG. 2D, respectively.

In an embodiment, the width and the length (A1 and A2 as indicated in FIG. 2D) of the third lower surface 32 may be, for example, 49.50 mm to 50.50 mm (with an optimal width of 50.00 mm) and 19.50 mm to 20.50 mm (with an optimal length of 20.00 mm), respectively.

Additionally, the width and the length (B1 and B2 as indicated in FIG. 2D) of the fourth surface unit 7 may be, for example, 0.99 mm to 1.01 mm (with an optimal width of 1.00 mm) and 16.09 mm to 16.11 mm (with an optimal length of 16.10 mm), respectively.

Referring to FIG. 1A to FIG. 2D together, the center of the second surface rectangle patch 51 and a center of the third surface slot 622 correspond to the center of the first liquid crystal layer 8, and the fourth surface strip patch 7 corresponds to the first liquid crystal layer 8.

The third surface rectangle patch 61 is a metal ground layer, and the fourth surface strip patch 7 is a microstrip line. The fourth surface strip patch 7 may be, for example, used as a signal feed line, while the third surface rectangle patch 61 may be, for example, used as a ground layer for the fourth surface strip patch 7.

By further explanation, the first liquid crystal layer 8 is disposed between the second substrate layer 2 and the third substrate layer 3, and both the second substrate layer 2 and the third substrate layer 3 have metal structures. Specifically, the second upper surface 21 has the second surface rectangle patch 51, and the third upper surface 31 and the third lower surface 32 respectively have third surface rectangle patch 61 and fourth surface strip patch 7 with metal structures. When a signal is coupled and fed from the fourth surface strip patch 7 into the broadband liquid crystal array antenna structure, there is a voltage difference between the fourth surface strip patch 7 and the second surface rectangle patch 51, thereby applying a bias voltage to the first liquid crystal layer 2 to control a beam scanning function of the broadband liquid crystal array antenna structure.

It should be noted that, in order to apply a bias voltage to the first liquid crystal layer 8, the edges of both the second substrate layer 2 and the third substrate layer 3 are designed as metal edges. This approach is a conventional technical means well known to those skilled in the art, so the edges of the second substrate layer 2 are not specifically indicated as metal edges in the drawings. The third surface slots 621 and 623 respectively correspond to the second surface large rectangle patches 521 and 531, and the second surface small rectangle patches 522 and 532 are connected to the edges of the second substrate layer 2. Therefore, when a signal is coupled and fed from the fourth surface strip patch 7 into the broadband liquid crystal array antenna structure, the parasitic patch groups 52 and 53 that are not directly connected to a feed source (that is, the fourth surface strip patch 7) and the second surface rectangle patch 51 (that is, the main radiating patch) generate resonance through coupling, thereby expanding a bandwidth of the broadband liquid crystal array antenna structure and achieving a function of controlling the beam scanning direction.

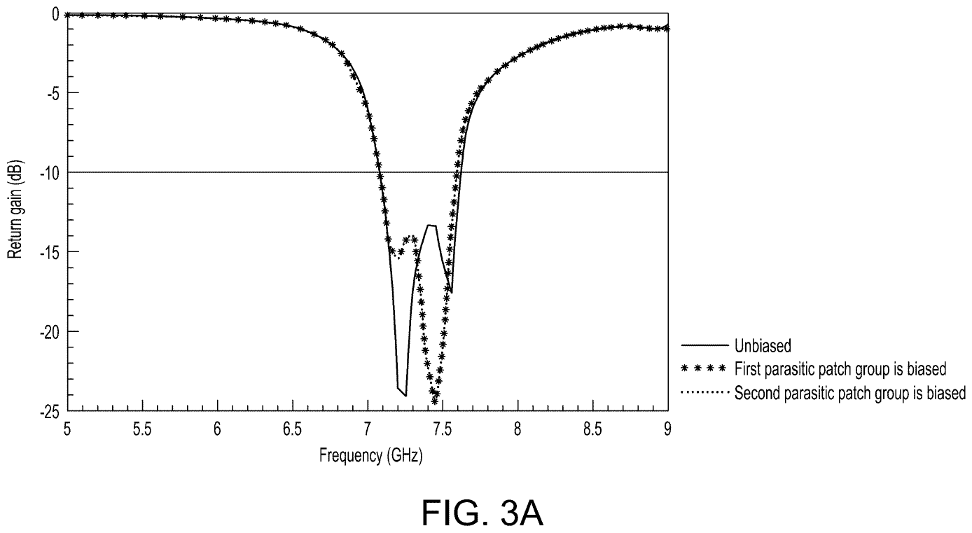

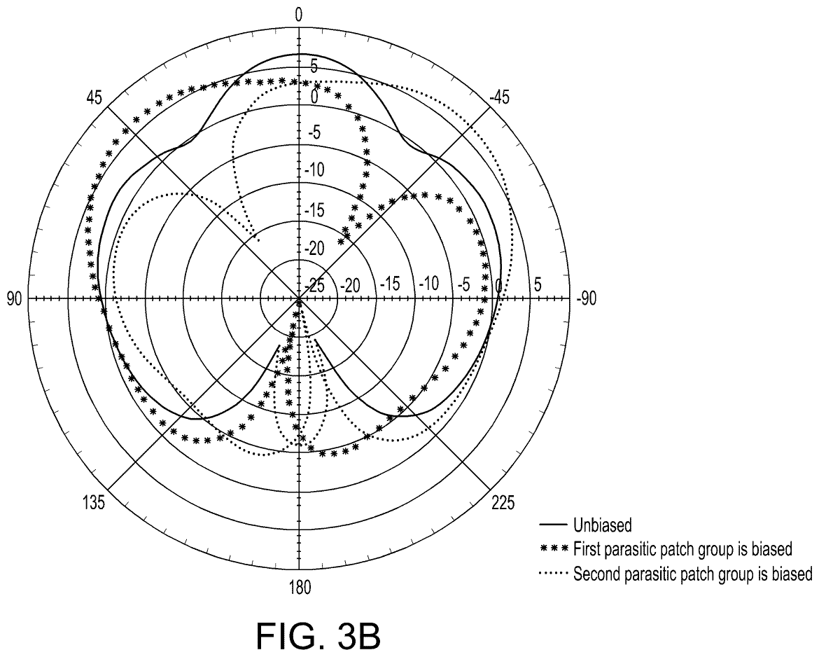

FIG. 3A is a relationship diagram between return gain and signal frequency of a broadband liquid crystal array antenna structure according to a first embodiment of the disclosure. FIG. 3B is a radiation pattern diagram of a broadband liquid crystal array antenna structure according to the first embodiment of the disclosure. An S11 parameter is also called an input reflection coefficient, which is used to indicate return loss at the signal transmitting end. The return gain is configured to represent an absolute value of the S11 parameter, with the unit being decibels (dB).

In this embodiment, referring to FIG. 3A and FIG. 3B, the liquid crystal material used for the first liquid crystal layer 8 is JNC ZOC-A018XX.

The unbiased condition in FIG. 3A and FIG. 3B is configured to indicate the S11 parameter of the broadband liquid crystal array antenna structure without power applied (that is, the first liquid crystal layer 8 is not applied with the bias voltage). When the first liquid crystal layer 8 is not applied with the bias voltage, the center operating frequency of the broadband liquid crystal array antenna structure is 7.08 gigahertz to 7.62 gigahertz, with −10 dB as a reference point, a bandwidth is 0.54 gigahertz, and a bandwidth ratio is 7.2%. In addition, when the first liquid crystal layer 8 is not applied with the bias voltage, a maximum gain of 6.94 dBi is achieved at a 0° reflection angle.

The first parasitic patch group in FIG. 3A and FIG. 3B is configured to indicate the S11 parameter of the broadband liquid crystal array antenna structure after the first parasitic patch group (that is, the parasitic patch group 52) is energized. By further explanation, in this embodiment, a 20-volt square wave is generated and provided by a signal generator (not shown) to the parasitic patch group 52 of the second surface unit 5 and the third surface rectangle patch 61 (that is, the metal ground layer) of the third surface unit 6. When the parasitic patch group 52 is applied with a bias voltage, the center operating frequency of the broadband liquid crystal array antenna structure is 7.07 gigahertz to 7.58 gigahertz, with −10 dB as the reference point, a bandwidth is 0.51 gigahertz, and a bandwidth ratio is 6.8%. In addition, when the parasitic patch group 52 is applied with a bias voltage, a maximum gain of 6.53 dBi is achieved at a 42° reflection angle.

The second parasitic patch group in FIG. 3A and FIG. 3B is configured to indicate the S11 parameter of the broadband liquid crystal array antenna structure after the second parasitic patch group (that is, the parasitic patch group 53) is energized. By further explanation, in this embodiment, a 20-volt square wave is generated and provided by the signal generator to the parasitic patch group 53 of the second surface unit 5 and the third surface rectangle patch 61 (that is, the metal ground layer) of the third surface unit 6. When the parasitic patch group 53 is applied with a bias voltage, the center operating frequency of the broadband liquid crystal array antenna structure is 7.07 gigahertz to 7.58 gigahertz, with −10 dB as the reference point, a bandwidth is 0.50 gigahertz, and a bandwidth ratio is 6.8%. When the parasitic patch group 53 is applied with a bias voltage, a maximum gain of 6.57 dBi is achieved at a −42° reflection angle.

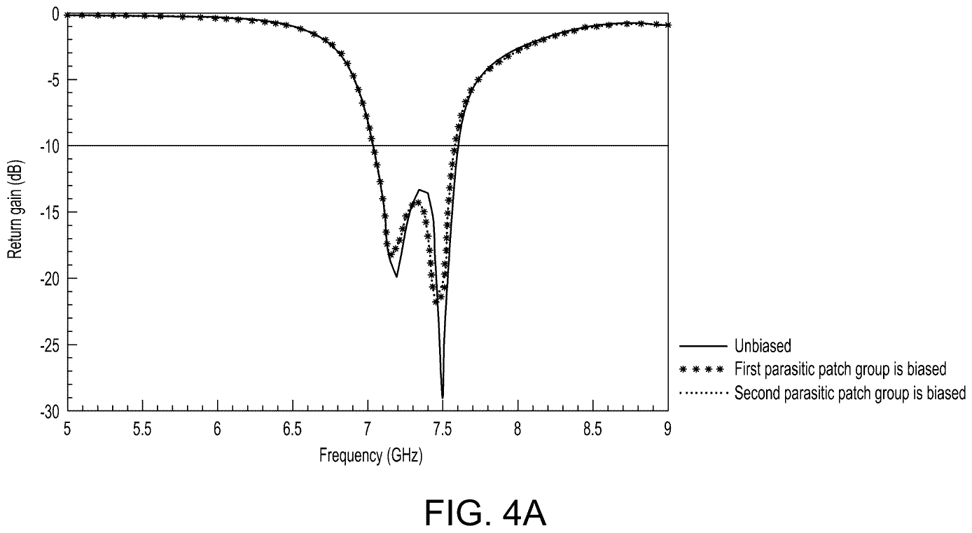

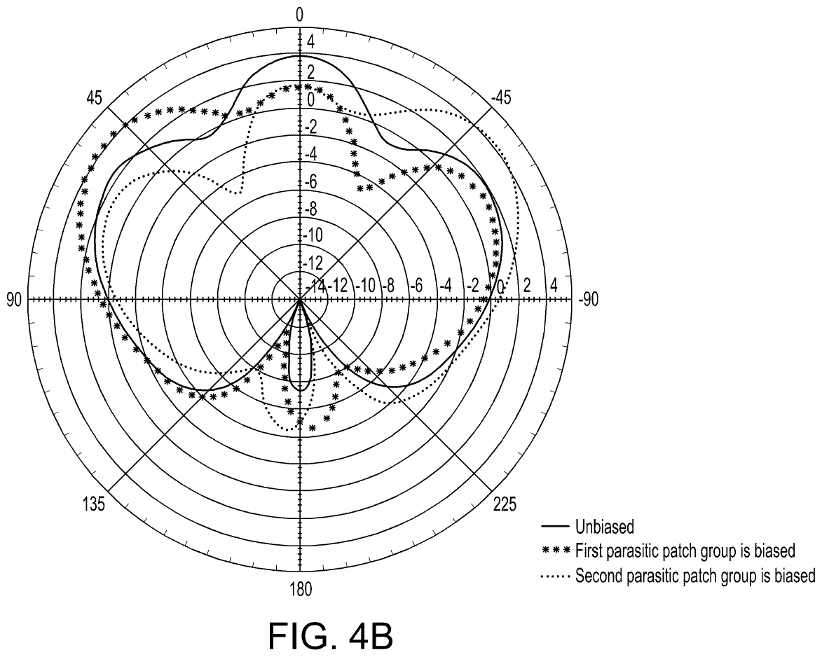

FIG. 4A is a relationship diagram between return gain and signal frequency of a broadband liquid crystal array antenna structure according to a second embodiment of the disclosure. FIG. 4B is a radiation pattern diagram of a broadband liquid crystal array antenna structure according to the second embodiment of the disclosure. In this embodiment, referring to FIG. 4A and FIG. 4B, the liquid crystal material used for the first liquid crystal layer 8 is MERCK E7.

As shown in FIG. 4A and FIG. 4B, when the first liquid crystal layer 8 is not applied with the bias voltage, the center operating frequency of the broadband liquid crystal array antenna structure is 7.04 gigahertz to 7.61 gigahertz, with −10 dB as the reference point, a bandwidth is 0.57 gigahertz, and a bandwidth ratio is 7.26%. In addition, when the first liquid crystal layer 8 is not applied with the bias voltage, a maximum gain of 3.94 dBi is achieved at a 0° reflection angle.

As shown in FIG. 4A and FIG. 4B, when the parasitic patch group 52 is applied with the bias voltage, the center operating frequency of the broadband liquid crystal array antenna structure is 7.03 gigahertz to 7.58 gigahertz, with −10 dB as the reference point, a bandwidth is 0.55 gigahertz, and a bandwidth ratio is 7.30%. In addition, when the parasitic patch group 52 is applied with the bias voltage, a maximum gain of 4.26 dBi is achieved at a 52° reflection angle.

As shown in FIG. 4A and FIG. 4B, when the parasitic patch group 53 is applied with the bias voltage, the center operating frequency of the broadband liquid crystal array antenna structure is 7.04 gigahertz to 7.58 gigahertz, with −10 dB as the reference point, a bandwidth is 0.54 gigahertz, and a bandwidth ratio is 7.20%. In addition, when the parasitic patch group 53 is applied with the bias voltage, a maximum gain of 4.26 dBi is achieved at a −52° reflection angle.

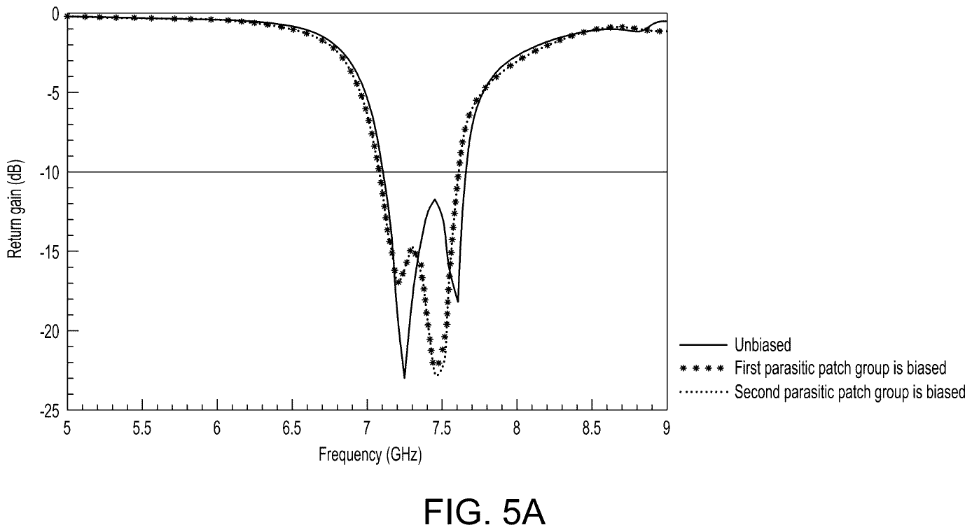

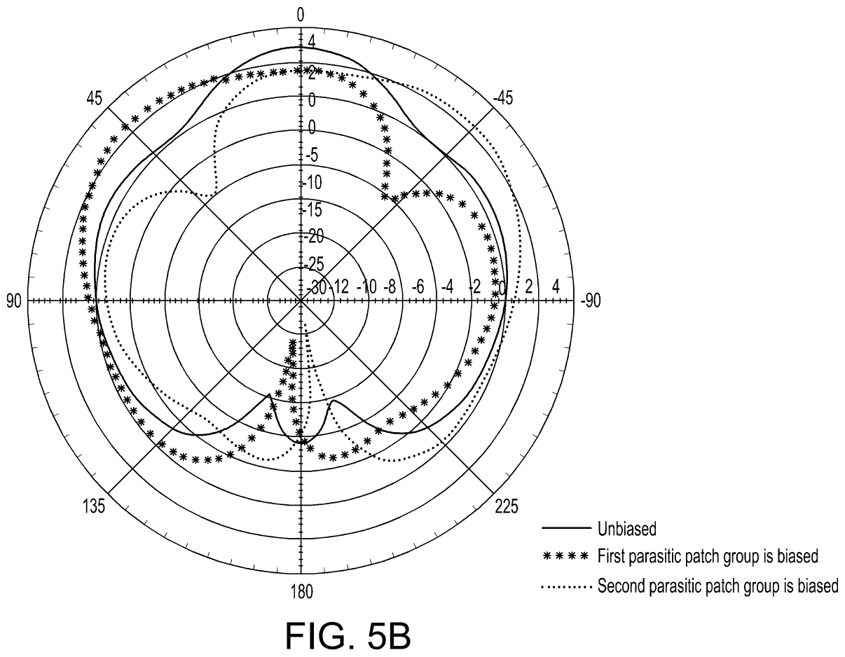

FIG. 5A is a relationship diagram between return gain and signal frequency of a broadband liquid crystal array antenna structure according to a third embodiment of the disclosure. FIG. 5B is a radiation pattern diagram of a broadband liquid crystal array antenna structure according to the third embodiment of the disclosure. In this embodiment, referring to FIG. 5A and FIG. 5B, the liquid crystal material used for the first liquid crystal layer 8 is MERCK GT7-29001.

As shown in FIG. 5A and FIG. 5B, when the first liquid crystal layer 8 is not applied with the bias voltage, the center operating frequency of the broadband liquid crystal array antenna structure is 7.11 gigahertz to 7.66 gigahertz, with −10 dB as the reference point, a bandwidth is 0.55 gigahertz, and a bandwidth ratio is 7.30%. In addition, when the first liquid crystal layer 8 is not applied with the bias voltage, a maximum gain of 7.02 dBi is achieved at a 0 degree reflection angle.

As shown in FIG. 5A and FIG. 5B, when the parasitic patch group 52 is applied with the bias voltage, the center operating frequency of the broadband liquid crystal array antenna structure is 7.09 gigahertz to 7.61 gigahertz, with −10 dB as the reference point, a bandwidth is 0.52 gigahertz, and a bandwidth ratio is 6.90%. In addition, when the parasitic patch group 52 is applied with the bias voltage, a maximum gain of 6.23 dBi is achieved at a 42° reflection angle.

As shown in FIG. 5A and FIG. 5B, when the parasitic patch group 53 is applied with the bias voltage, the center operating frequency of the broadband liquid crystal array antenna structure is 7.08 gigahertz to 7.60 gigahertz, with −10 dB as the reference point, a bandwidth is 0.52 gigahertz, and a bandwidth ratio is 6.90%. In addition, when the parasitic patch group 53 is applied with the bias voltage, a maximum gain of 6.25 dBi is achieved at a −42° reflection angle.

Based on the aforementioned FIG. 3A to FIG. 5B, it may be known that a range (also called a first angular range) for the broadband liquid crystal array antenna structure to perform beam scanning is determined by the material of the first liquid crystal layer 8. If the material of the first liquid crystal layer 8 is JNC ZOC-A018XX or MERCK GT7-29001, when the first liquid crystal layer 8 is applied with the bias voltage, the broadband liquid crystal array antenna structure may perform beam scanning based on the first scanning angle (that is, −42° to) 42°. Furthermore, if the material of the first liquid crystal layer 8 is MERCK E7, when the first liquid crystal layer 8 is applied with the bias voltage, the first scanning angle is −52° to 52°.

For ease of understanding, characteristics of the broadband liquid crystal array antenna structure using different liquid crystal materials are listed in Table 2, where-10 dB and center operating frequency of 7.50 kilohertz are used as reference in Table 2.

TABLE 2

| | Center | | | | |
|---|---|---|---|---|---|
| Liquid | operating | | | | |
| crystal | frequency | Size | Bandwidth | Scanning | Gain |
| material | (GHz) | (mm) | (%) | range (°) | (dBi) |
| JNC ZOC- | 7.50 | 50*20 | 7.20 | −42° to 42° | 6.94 |
| A018XX | | | | | |
| MERCK | 7.50 | 50*20 | 7.60 | −52° to 52° | 3.96 |
| E7 | | | | | |
| MERCK | 7.50 | 50*20 | 7.30 | −42° to 42° | 7.20 |
| GT7-29001 | | | | | |

In summary, the broadband liquid crystal array antenna structure provided by the embodiments of the disclosure controls the scanning beam thereof by using the liquid crystal material. When the liquid crystal material is applied with the bias voltage, the broadband liquid crystal array antenna structure may perform beam scanning based on a wide scanning range (−42° to 42°, or −52° to) 52°, and the continuous scanning range may cover 84° (or 104°), so that the requirement of high-precision ultra-wide band (UWB) indoor positioning is met.

Finally, it should be noted that: the aforementioned embodiments are only used to illustrate the technical solutions of the present invention, rather than to be limit the same. Although the disclosure has been described in detail with reference to the aforementioned embodiments, those skilled in the art should understand that: the technical solutions described in the aforementioned embodiments may still be modified, or equivalent substitutions for some or all of the technical features thereof may be made. These modifications or substitutions do not cause the essence of the corresponding technical solutions to depart from the scope of the technical solutions of the embodiments of the disclosure.

What is claimed is:

1. A broadband liquid crystal array antenna structure, comprising:
a first substrate layer, having a first upper surface and a first lower surface;
a second substrate layer, having a second upper surface and a second lower surface;
a third substrate layer, having a third upper surface and a third lower surface;
a first liquid crystal layer, stacked and connected between the second substrate layer and the third substrate layer;
a first surface unit, arranged on the first upper surface;
a second surface unit, arranged on the second upper surface;
a third surface unit, arranged on the third upper surface; and
a fourth surface unit, arranged on the third lower surface,
wherein when the first liquid crystal layer is applied with a bias voltage, the broadband liquid crystal array antenna structure performs beam scanning based on a first angular range.

2. The broadband liquid crystal array antenna structure according to claim 1,
wherein the first surface unit comprises a first surface large rectangle patch and four first surface small rectangle patches,
wherein a center of the first surface large rectangle patch corresponds to a center of the first liquid crystal layer,
wherein two of the four first surface small rectangle patches are adjacent to a first side of the first surface large rectangle patch, and another two of the four first surface small rectangle patches are adjacent to a second side of the first surface large rectangle patch, and
wherein the first side is opposite to the second side.

3. The broadband liquid crystal array antenna structure according to claim 1,
wherein the second surface unit comprises a second surface rectangle patch and two parasitic patch groups,
wherein a center of the second surface rectangle patch corresponds to a center of the first liquid crystal layer,
wherein one of the parasitic patch groups is adjacent to a first side of the second surface rectangle patch, and another one of the parasitic patch groups is adjacent to a second side of the second surface rectangle patch, and
wherein the first side is opposite to the second side.

4. The broadband liquid crystal array antenna structure according to claim 3,
wherein the second surface rectangle patch is a main radiating patch.

5. The broadband liquid crystal array antenna structure according to claim 3,
wherein each of the parasitic patch groups comprises a second surface large rectangle patch, a second surface small rectangle patch, and a second surface strip patch,
wherein the second surface large rectangle patch is connected to the second surface small rectangle patch through the second surface strip patch,
wherein the second surface large rectangle patch is adjacent to the second surface rectangle patch, and
wherein the second surface small rectangle patch is connected to an edge of the second upper surface.

6. The broadband liquid crystal array antenna structure according to claim 1, wherein the third surface unit is a metal ground layer.

7. The broadband liquid crystal array antenna structure according to claim 1,
wherein the third surface unit comprises a third surface rectangle patch, and
wherein the third surface rectangle patch comprises three third surface slots arranged sequentially along a first direction, and a center of a second third surface slot of the three third surface slots corresponds to a center of the first liquid crystal layer.

8. The broadband liquid crystal array antenna structure according to claim 7,
wherein the third surface slot is an H-shaped slot,
wherein an H-shape of the third surface slot extends along a second direction, and
wherein the first direction is relative to the second direction.

9. The broadband liquid crystal array antenna structure according to claim 1,
wherein the fourth surface unit is a fourth surface strip patch, and
wherein the fourth surface strip patch extends along a second direction and corresponds to a center of the first liquid crystal layer.

10. The broadband liquid crystal array antenna structure according to claim 9,
wherein the fourth surface strip patch is a signal feed line.

11. The broadband liquid crystal array antenna structure according to claim 9,
wherein the fourth surface strip patch is a microstrip line.

12. The liquid crystal array antenna structure according to claim 1, wherein the first surface unit, the second surface unit, the third surface unit, and the fourth surface unit are formed by metal materials.

13. The liquid crystal array antenna structure according to claim 1, wherein the first angular range is determined by a material of the first liquid crystal layer.

14. The liquid crystal array antenna structure according to claim 1, wherein the first angular range is between −42° and 42°.

15. The liquid crystal array antenna structure according to claim 1, wherein the first angular range is between −52° and 52°.
